(19) United States
(12) Patent Application Publication
(10) Pub. No.: US 2011/0309135 A1
(43) Pub. Date: Dec. 22, 2011

(54) Paperboard carton and method of manufacture therefor

(76) Inventors: Al Carbone, Ile Bizard (CA); Gilles Guimond, Laval (CA); Karyn Nakhleh, Pincourt (CA)

(21) Appl. No.: 13/067,686

(22) Filed: Jun. 21, 2011

Related U.S. Application Data
(60) Provisional application No. 61/344,264, filed on Jun. 21, 2010.

(51) Int. Cl. B65D 5/24; B31B 3/00

(52) U.S. Cl. 229/187; 493/162

(57) ABSTRACT

A foldable carton cut from a generally planar sheet of foldable paper material having a grain orientation, for forming a carton box therewith, has a rectangular intermediate section with first and second side flapped sections extending from and foldable relative to opposed respective first and second flapped section intersections thereof that are at a non-orthogonal angle relative to the grain orientation. Each first and second side flapped section has generally opposed first and second side flaps extending alongside thereof adjacent the intermediate section and are foldable relative thereto along respective first and second cut-score formation sets. The first and second cut-score formation sets of the first and second side flapped sections are substantially perpendicular to the respective flapped section intersection, positioned in a diagonally alternating fashion relative to the intermediate section, and different form one another. The present invention also refers to a method of manufacturing the carton box.

### CROSS REFERENCE TO RELATED APPLICATION

Benefit of U.S. Provisional Application for Patent Ser. No. 61/344,264 filed on Jun. 21, 2010, which is incorporated herein by reference, is hereby claimed.

### FIELD OF THE INVENTION

The present invention relates to packaging, and is more particularly concerned with a paperboard carton and method of manufacture therefore.

### BACKGROUND OF THE INVENTION

Paperboard packaging, such as paperboard folding cartons for packaging of products, is well known in the art. Typically, such cartons are cut, with dies or dies using sheets, for example as part of a cartoning machine or process, as cut-outs or blanks from rolls or webs of paperboard. The cut-outs have creases or scores formed therein at areas where the cut outs must be folded to form the different faces and connector portions or flaps of the carton and the paperboard often has desired graphics and images inscribed thereon prior to cutting. Each cut-out is then folded with at least some of the connector portions connected together to at least partially assemble the cut outs into partially assembled cartons having an opening and the products are inserted into the carton through the opening, for example with the cartoning machine or a packaging machine. Finally, the openings of the partially assembled cartons are closed by connecting the remaining free edges of the cut outs.

Typically, cartons manufactured as described above are printed and cut with, i.e. in axial alignment with, the grain of the paperboard web. However, cutting diagonally across the grain often may allow for a greater number of cut-outs, compared to cutting with the grain, for packages to be formed from a given quantity of paperboard. U.S. Pat. No. 5,232,149 issued to Stoll and U.S. patent application Ser. No. 10/384,033 by Collura both provide examples of containers formed diagonally against the grain of a paperboard and/or corrugated cardboard sheet. However, while cutting and scoring the cut-outs against the grain may allow more cartons to be formed from a given quantity of paperboard, cartons formed in such fashion often have a tendency to slant or curve along creases or scores formed therein due to the formation against the grain. Thus, walls of cartons formed against the grain may tend to warp or lose alignment, thus causing the shape of the container, including the aperture through which product is inserted therein, to warp somewhat. Thus, cartons formed against the grain have a greater risk of being misaligned with packaging or cartoning machines at the packaging stage in which the product is placed therein, thus increasing risks of packaging difficulties.

Accordingly, there is a need for an improved folded carton and method of manufacture therefor.

### SUMMARY OF THE INVENTION

It is therefore a general object of the present invention to provide an improved folded carton and method of manufacture therefor.

An advantage of the present invention is that the folded carton and method of manufacture therefor uses less board hence greater yield.

Another advantage of the present invention is that the folded carton and method of manufacture therefor provides a folded carton cut against the grain and which, when partially assembled for packaging of product therein, maintains the desired shape at an aperture for packaging of the product therein through the aperture.

According to an aspect of the present invention, there is provided a foldable carton cut from a generally planar sheet of foldable paper material having a grain orientation for forming a carton box therewith, said carton comprising:
a generally rectangular intermediate section having first and second side flapped sections extending from and foldable relative to opposed respective first and second flapped section intersections thereof, said first and second flapped section intersections being at a non-orthogonal angle relative to the grain orientation;
each said first and second side flapped sections has generally opposed first and second side flaps extending alongside thereof adjacent said intermediate section and being foldable relative thereto along respective first and second cut-score formation sets, wherein said first and second cut-score formation sets of said first and second side flapped sections being substantially perpendicular to respective said flapped section intersection, being positioned in a diagonally alternating fashion relative to said intermediate section, and being different form one another.

According to another aspect of the present invention, there is provided a method of manufacturing the hereinabove carton.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a top plan view of a sheet of paper material showing a plurality of folded cartons cut therein in accordance with an embodiment of the present invention;

FIG. 2 is a top plan view of the printed side of one of the folded cartons shown in FIG. 1 after removal from the sheet and in a flat first configuration;

FIG. 3 is a side perspective view of the folded carton shown in FIGS. 1 and 2 showing folding of side sections and side connecting tabs thereof; and

FIG. 4 is a top plan view of a sheet of paper material showing the cartons cut in alignment with a grain of the sheet.

### DETAILED DESCRIPTION OF THE PREFERRED EMBODIMENTS

With reference to the annexed drawings the preferred embodiments of the present invention will be herein described for indicative purpose and by no means as of limitation.

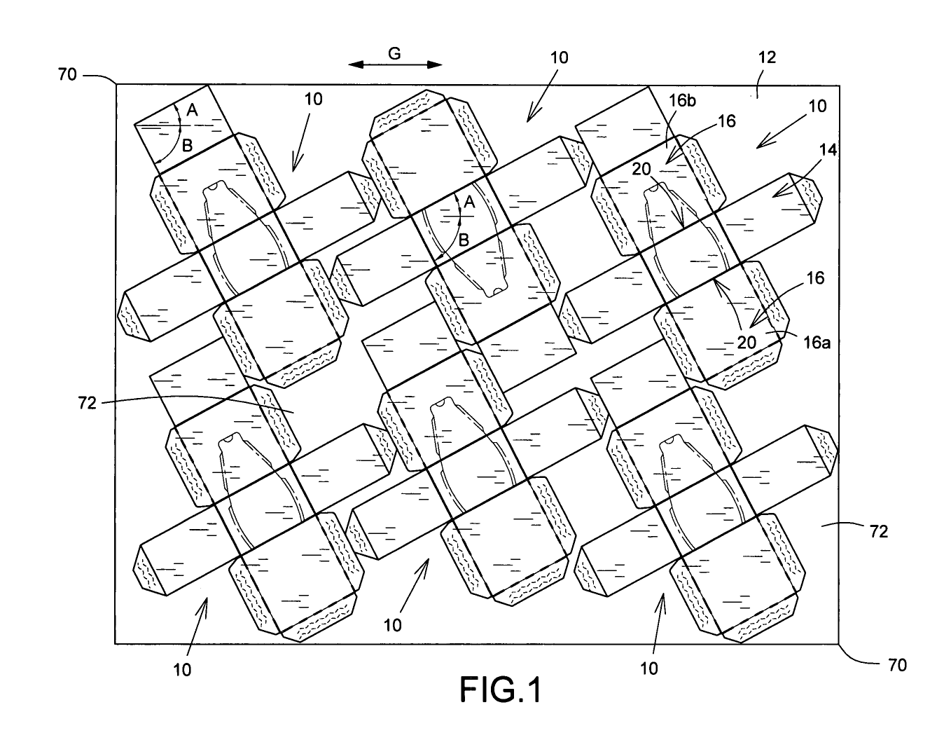

Reference is now made to FIGS. 1, 2, and 3. As shown, a plurality of cartons, shown generally as 10 are formed, for example cut, from a preferably rectangular sheet 12 of foldable paper material. Typically, the foldable paper material is paperboard, although other foldable paper materials, such as cardboard or corrugated cardboard may be used. The forming of the cartons 10 is typically effected, as is known in the art, by use of a corresponding die, for example a die plate, of identical configuration to the sheet 12 and cartons 10 shown in FIG. 1. Typically the die uses sharp edges to effect the cuts in the paper material, for example cuts between the cartons 10 or within a carton 10, and round edges to form foldable scores within each carton 10. The formation of the cartons 10 in the sheet 12 may be effected, for example, with a die in a cartoning machine or simply with a separate die press, not shown. As is typically known in the art, images and text for the cartons 10 are preferably formed on the sheet 12 thereon prior to the cutting/formation of the cartons 10.

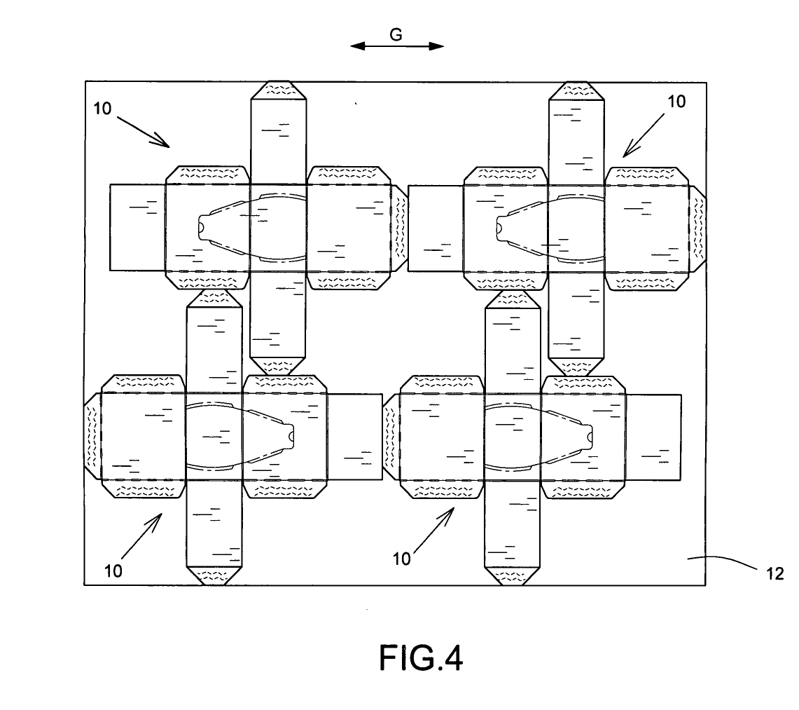

Referring now to FIGS. 1 and 4, to maximize the number of cartons 10 formed on sheet 12, the cartons 10 are formed and cut diagonally on the sheet 12 between corners 70, generally one carton 10 abutting another, in an angular orientation that goes against, i.e. diverges from, the grain G of sheet at non-orthogonal (different than 0 and 90 degrees) angles A and B, typically between 5 and 85 degrees each, for example 28 and 62 degrees, respectively. The die, not shown, is formed in the same configuration as the cartons 10 and sheet 12 shown in FIG. 1. As shown in FIGS. 1 and 4, the cutting configuration of FIG. 1, with the against-the-grain orientation, allows for a greater number of cartons 10 to be formed from the sheet 12 than if the cartons 10 are formed in alignment with the grain, shown in FIG. 4. Once the cartons 10 are formed and cut in sheet 12 with, excess portions 70 are removed. It should be noted that while a particular type of rectangular carton 10 and orientation on sheet 10 is shown, other configurations and arrangements for different sizes of cartons 10 and sheets 12 can be deployed and will often yield more cartons 10 per sheet 12 with an against-the-grain orientation compared to a with-the-grain orientation.

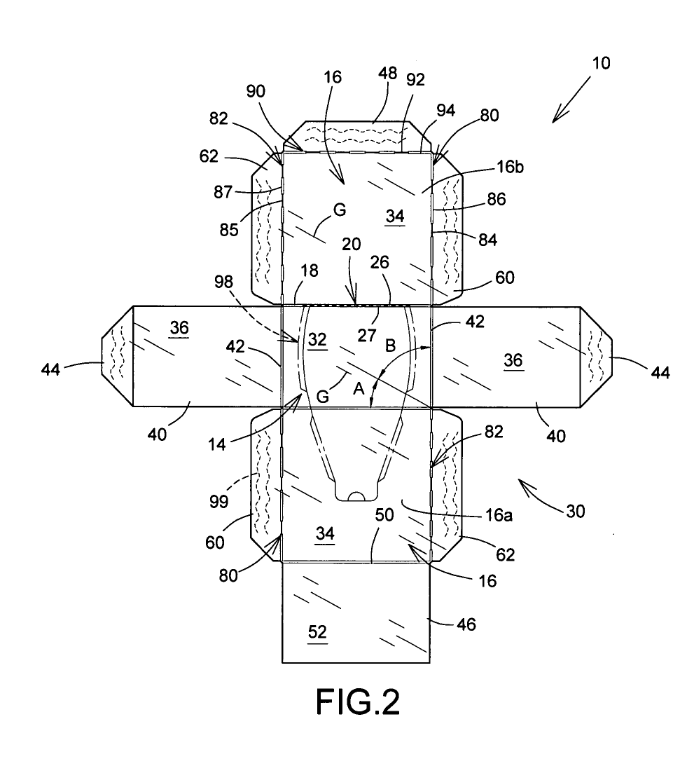

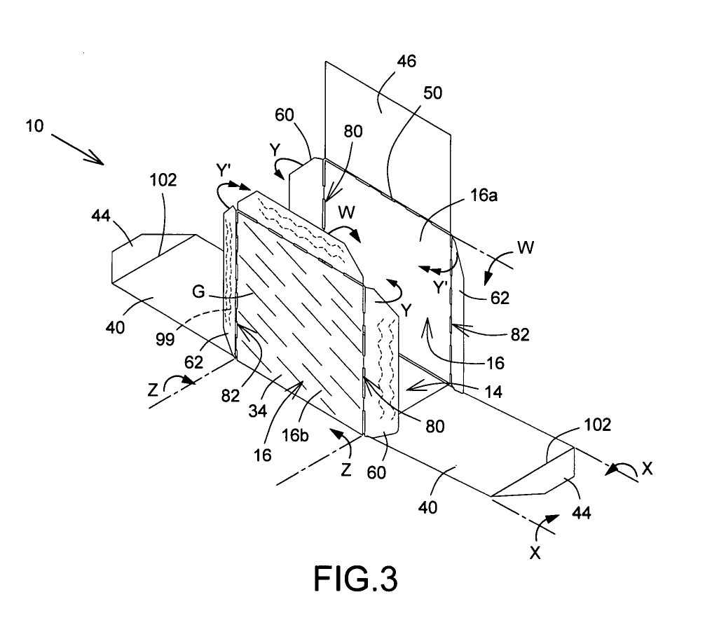

As best shown in FIGS. 2 and 3, each carton 10 is formed with a preferably rectangular intermediate section 14, or top panel, with longitudinally opposed rectangular first 16a and second 16b side flapped sections 16, or long panels, preferably identical in side and shape, extending from opposed respective first and second flapped section edges or intersections 18 of intermediate section 14 which intersect side flapped section 16a, 16b. The score intersections 18 are also inwardly extending scored relative outer surfaces 32, 34 which facilitates folding of sections 16 thereupon as shown by arrow X. Each side flapped section 16 has generally opposed side flaps 60, 62 extending alongside thereof adjacent section 14. First and second rectangular, and preferably identical, unflapped or free side sections 40, or short panels, are also cut longitudinally opposed to one another and extending from opposed unflapped section edges or intersections 42, each consisting of an inwardly extending (i.e. protruding) unflapped side edge score 42 relative outer surfaces 32, 26 of intermediate section 14 and unflapped side sections 40. Unflapped side sections 40 extend, i.e. are cut on sheet 12, generally perpendicular to side flapped sections 16 and are easily foldable as shown by arrow Z at scores 42.

A foldable rectangular end section 46, or bottom panel, preferably identical to the intermediate section 14, and in this case used to form the bottom panel of the folded box, is cut extending from the first side flapped section 16a and extends collinearly therewith along an end section edge or intersection 50 with the section 16a Intersection 50 is a protruding end section score 50 formed with die to extend inwardly relative respective outer surfaces 52, 34 of sections 16a, 46, the inward protrusion of score 50 facilitating folding of end section 46 as shown by arrow W towards section 16b and end flap 48. Foldable end flap 48, longitudinally opposite the end section 46 extends along second side flapped section 16b adjacent foldable side flaps 60, 62 thereof.

The carton 10 is formed with, for respective first and second side flaps 60, 62 for each side flapped section 16, a respective first side cut-score set 80 and an opposite second side cut-score set 82 of longitudinally extending and alternating respective side cuts 84, 85 and side scores 86, 87, the flaps 60, 62 being foldable relative side flap sections 16, as shown by arrows Y, Y′ on sets 80, 82, respectively. The sets 80 and 82 extend outwardly from intermediate section 14, generally perpendicularly to unflapped sections 40 and in parallel, typically longitudinal collinear alignment with unflapped section scores 42, on opposing sides of the side flapped section 16. Further, the second side flapped section 16b has a cut-score end set, shown generally as 90, of end cuts 92 and scores 94 extending longitudinally between side flap 16b and end flap 48 from sets 80, 82, the end scores 92 intersecting on one and forming perpendicular corners therewith. The side scores 86, 87 of first side flapped section 16a adjacent end section 46 intersect end section score 50 to form perpendicular corners therewith and the side scores 86, 87 adjacent end flap 48 each intersect a score 94 of end set 90 to form corners therewith. The scores 86, 87, 50 and 94 are formed extending inwardly relative outer surfaces 34 and 52 to facilitate folding as shown by arrows Y, Y′ and W.

As sections 16 are identical in rectangular size and shape, along with sections 14 and 52 and sections 40, the carton 10 can be folded from an unfolded or flat configuration, shown generally as 30, in which all sections 14, 16, 40, 52, tabs 44, and flaps 48, 60, 62 are laid out flat in planar alignment towards one another, as shown by arrows W, X, Y, Y′, Z to form a rectangular carton 10 when sections 14, 16, 40, 52 are connected together by tabs 44 and flaps 48, 60, 62. Specifically, the side flaps 60, 62 of each side flap section 16a, 16b are folded toward one another, shown by arrow Y, Y′, and the side flap sections 16a 16b are folded toward one another, shown by arrow X, along intersections 18. The unflapped sections 40 are folded on scores 42 towards one another, shown by arrow Z, and then connected, for example with staples, glue or other adhesives, on inner surface 36 to flaps 60, 62. End tabs 44 are then folded over flaps 60, 62 at end tab scores or cuts 102 and unflapped sections 40 and connected thereto, again with glue (shown as waving lines 99), staples or other adhesives. Thus, the carton 12 is partially assembled with a packaging extending between, and defined by, connected sections 16a, 16b, 40 sections. Product may then be placed in the carton through the aperture, again using a cartooning machine or packaging machine. Finally, the end section 46 is folded, shown by arrow W towards section 16b and connected to end flap 48, again with glue 99, adhesives, or any other conventional means deployed in packaging techniques, to completely close the carton 10 with the product packaged therein. The assemblage from the unfolded configuration and connection of sections 16, 46, 40 to tabs 44 and flaps 60, 62, 48 may be accomplished manually or with cartoning machines, as is well known in the art.

Additionally, the respective scores 86 and cuts 84 of first side set 80 of first side flapped section 16a are typically colinearly aligned with score 42 and scores 87 and cuts 85 of second side set 82 of second flapped section 16b. Similarly, the respective scores 87 and cuts 85 of second side set 82 of first side flapped section 16a are typically colinearly aligned with score 42 and scores 86 and cuts 84 of first side set 80 of second flapped section 16b. Thus, the longer scores 86 for first side set 80 for the first side flapped section 16a are diagonally opposite the longer scores 86 for first side set 80 for the second side flapped section 16b and the shorter scores 87 for second side set for the first side flapped section 16a are diagonally opposite the shorter scores 87 for first side set 80 for the second side flapped section 16b. In the specific illustrated, the cuts 85, 85 of the two sets 80, 82 are of a same length, but could eventually be different in another embodiment (not shown).

Advantageously, the inward protrusion of scores 18, 28, 42, 50, 86, 87, 94 relative to surfaces 34, 36, 52, and thus their indentation into the opposing surfaces facilitates folding from the unfolded configuration in the directions shown by arrows W, X, Y, Y′, Z while impeding folding from the unfolded configuration in the opposite directions. Thus, proper assembly, whether manual or automated is facilitated and errors and improperly formed cartons are reduced, once again in reducing the amount of board consumption, saving money, and reducing detrimental environmental impact.

Because of the different orientations relative to the grain direction G (angles A and B) of intersections 18 and 42, and therefore the different rigidity or ‘memory effect’ of the carton thereat, added to the fact that the intersections have different lengths relative to one another, the carton has a natural tendency to warp or distort when it is being folded into a box configuration, and thus being improperly formed or shaped such that an automated filling of the box essentially becomes impossible, particularly when product is being placed therein as described above.

In order to counteract against, or oppose to that warping due to the different orientations (angles A and B) of the respective intersections 18, 42 relative to the grain G, different sets 80, 82 are used between the sections 16 and the respective flaps 60, 62. With the same length of cuts 84, 85 and longer scores 86 than scores 87 provided for flaps 60, 62, respectively, flaps 62 would fold more easily away surface 34 than flaps 60 would do, because of more cuts in proportion along the flap length, thus creating a tendency for the container to warp slightly at connections with flaps 60, 62 pushing (due to the ‘memory effect’ of the carton at the flap fold line) against respective section 40 when the carton is being maintained into the folded configuration, during filling thereof. This slight warp at the flap fold lines 80, 82 induced by a different selection of cuts 84, 85 and scores 86, 87 thereat, respectively, in size and quantity, thereby having different proportions of the length of the respective set 80, 82 made of scores versus cuts, is provided to essentially counteract the natural warping of the carton in the folded configuration due to angles A and B of intersections 18, 42 relative to the grain G.

Hence, the longer scores 86 of diagonally opposite first sets 80 create additional resistance to folding inward (because of less cut material along the fold line, in proportion), shown by arrow Y, at diagonally opposed corners or junctions formed by sections 40, 16 by connection of flaps 60 to unflapped section 40, as compared to diagionally opposed junctions formed by sections 40, 16 by connection of flaps 62, shown by arrow Y′. This additional resistance, or additional force directed in the opposite direction of arrow Y when sections 40, 16 are connected at flap 60, compared to less resistance at flap 62, compensates for this problem of natural box warping created by the angular orientations of the intersections 18, 42 relative the grain G and reduces issues during packaging as well as board consumption (increased yield).

If desired, one or both of the unflapped section intersections 18 may be cut and scored, with a respective cut-score intersection set 20 of alternating intersection cuts 28 and protruding intersection scores 26 disposed generally centrally on the intersection 18. The remainder of the intersection 18 is scored with first and second intersection end scores 22 between which the set 20 extends, the scores 22, 26 being protruding scores 22, 26 relative outer surfaces of sections 14, 16 in that they protrude inwardly from surface. The intersection cuts 28 and scores 26 are much smaller in length than scores 22 and facilitate tearing of breakage of the carton 10 along cuts and scores 28, 26 between end scores 22, for example to facilitate removal of a predefined portion 98, shown by dot-dash lines, of carton 10 to create an aperture for removal of product packaged in the carton 10. Further, if desired and to facilitate connection of flaps 60, 62, 48 and tabs 44 to sections 16, 62, 40, flaps 60, 62 may taper inwardly on at least one end thereof and end flap 48 and end tabs 44 taper inwardly from both ends thereof.

Although the carton 10 of the present invention, and shown in FIGS. 1 to 3, is provided with panel intersections 18, 42 essentially perpendicular to adjacent ones, any angle(s) there between could be considered without departing from the scope of the present invention, as well as the quantity of panels (and therefore respective intersections and angles relative to the grain G) connected to the intermediate panel 14.

Although the present carton and method of manufacture therefore have been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

We claim:

1. A foldable carton cut from a generally planar sheet of foldable paper material having a grain orientation for forming a carton box therewith, said carton comprising:
a generally rectangular intermediate section having first and second side flapped sections extending from and foldable relative to opposed respective first and second flapped section intersections thereof, said first and second flapped section intersections being at a non-orthogonal angle relative to the grain orientation;
each said first and second side flapped sections has generally opposed first and second side flaps extending alongside thereof adjacent said intermediate section and being foldable relative thereto along respective first and second cut-score formation sets, wherein said first and second cut-score formation sets of said first and second side flapped sections being substantially perpendicular to respective said flapped section intersection, being positioned in a diagonally alternating fashion relative to said intermediate section, and being different form one another.

2. A method of manufacturing the carton of claim 1.
